(19) United States
(12) Patent Application Publication
(10) Pub. No.: US 2025/0182488 A1
(43) Pub. Date: Jun. 5, 2025

(54) APPARATUS AND METHOD FOR SURVEILLANCE

(71) Applicant: HANWHA VISION CO., LTD., Seongnam-si (KR)

(72) Inventors: Byoung Man AN, Seongnam-si (KR); Jin Hyuk CHOI, Seongnam-si (KR)

(73) Assignee: HANWHA VISION CO., LTD., Seongnam-si (KR)

(21) Appl. No.: 19/046,146

(22) Filed: Feb. 5, 2025

Related U.S. Application Data
(63) Continuation of application No. PCT/KR2023/014617, filed on Sep. 25, 2023.

(30) Foreign Application Priority Data
Sep. 26, 2022 (KR) 10-2022-0121340

(51) Int. Cl. G06V 20/52; G06F 21/62; G06T 7/20; G06T 11/40; G06V 10/70; G06V 40/10

(52) U.S. Cl. CPC G06V 20/52; G06F 21/6254; G06T 7/20; G06T 11/40; G06V 10/70; G06V 40/10; G06T 2207/20081; G06T 2207/30196; G06T 2207/30232; G06V 2201/07

(57) ABSTRACT

A surveillance apparatus includes: a memory storing instructions; and one or more processors configured to execute the instructions, where, by executing the instructions, the one or more processors are configured to control: an camera to generate an image by capturing a surveillance area, and an image processing module to perform masking on a target object included in the image based on masking conditions for the target object being satisfied, and where the masking conditions are based on at least one of a distance between the target object and a reference object included in the image, and an overlapping area between the target object and the reference object included in the image.

### CROSS REFERENCE TO RELATED APPLICATION(S)

This application is a continuation of International Application No. PCT/KR2023/014617, filed on Sep. 25, 2023, in the Korean Intellectual Property Receiving Office, which is based on and claims priority to Korean Patent Application No. 10-2022-0121340, filed on Sep. 26, 2022, in the Korean Intellectual Property Office, the disclosures of which are incorporated by reference herein in their entireties.

### BACKGROUND

### 1. Field

The present disclosure relates to a surveillance apparatus and method, and more particularly, to a surveillance apparatus and method for generating a surveillance image by applying a privacy mask to objects within a surveillance area that require privacy protection.

### 2. Description of Related Art

Cameras can be used for surveillance purposes in targeted locations. Users can monitor the relevant locations by referencing the images captured by the cameras.

A surveillance area may include a plurality of different objects. The objects may include people, and some objects may require protection of their privacy to ensure that their identities are not exposed.

Surveillance cameras may be installed in locations with frequent human traffic, such as hospitals, hotels, or department stores. However, if the cameras capture the faces of individuals requiring privacy protection, privacy violations may occur.

Accordingly, there is a need for a device that ensures the identity of objects requiring privacy protection within the surveillance area is not exposed.

### SUMMARY

Provided is a surveillance apparatus and method that generates a surveillance image by applying a privacy mask to objects within a surveillance area that require privacy protection.

Aspects will be set forth in part in the description which follows and, in part, will be apparent from the description, or may be learned by practice of the presented embodiments.

According to an aspect of an embodiment, a surveillance apparatus may include: a memory storing instructions; and one or more processors configured to execute the instructions, where, by executing the instructions, the one or more processors are configured to control: an camera to generate an image by capturing a surveillance area, and an image processing module to perform masking on a target object included in the image based on masking conditions for the target object being satisfied, and where the masking conditions are based on at least one of a distance between the target object and a reference object included in the image, and an overlapping area between the target object and the reference object included in the image.

The one or more processors may be further configured to control the image processing module to: detect the target object and the reference object included in the image; and track the detected target object.

The one or more processors may be further configured to control the image processing module to perform masking on an entirety of the target object or a predefined part of the target object.

The one or more processors may be further configured to control the image processing module to maintain masking on the target object in a state in which the masking conditions are no longer satisfied after masking has been performed.

The one or more processors may be further configured to control the image processing module to, based on multiple target objects in the image satisfying the masking conditions, perform masking only on a target object that first satisfies the masking conditions.

Based on the target object being a person, the predefined part may include a head of the person.

The one or more processors may be further configured to perform on-site training of an object in the image using an artificial intelligence (AI) model based on a user input setting the object as the target object or the reference object.

The masking conditions may be satisfied based on at least one of: the distance between the target object and the reference object being less than a predetermined threshold, and the overlapping area between the target object and the reference object exceeding a preset threshold area.

The one or more processors may be further configured to control the image processing module to: detect the target object and the reference object included in the image using the AI model, track the reference object and the target object included in the image, and determine that the masking conditions are satisfied based on at least one of: the distance between the target object and the reference object being less than a predetermined threshold, and the overlapping area between the target object and the reference object exceeding a preset threshold area.

According to an aspect of an embodiment, a surveillance system may include: a surveillance apparatus configured to generate an image by capturing a surveillance area; a management apparatus configured to store the image; and a user terminal connected to the management apparatus and configured to output the image, where the surveillance apparatus includes one or more processors configured to control an image processing module to perform masking on a target object included in the image based on masking conditions for the target object being satisfied, and where the masking conditions are based on spatial relationships between the target object and a reference object included in the image.

The spatial relationships may be based on at least one of a distance between the target object and the reference object and an overlapping area between the target object and the reference object.

The one or more processors of the surveillance apparatus may be further configured to perform on-site training of an object in the image using an artificial intelligence (AI) model based on a user input setting the object as the target object or the reference object.

The one or more processors of the surveillance apparatus may be further configured to control the image processing module to: detect the target object and the reference object included in the image using the AI model, track the target object and the reference object included in the image, and determine that the masking conditions are satisfied based on at least one of: a distance between the target object and the reference object being less than a predetermined threshold, and an overlapping area between the target object and the reference object exceeding a preset threshold area.

The one or more processors of the surveillance apparatus may be further configured to control the image processing module to, based on multiple target objects in the image satisfying the masking conditions, perform masking only on a target object that first satisfies the masking conditions.

The one or more processors of the surveillance apparatus may be further configured to control the image processing module to maintain masking on the target object that first satisfies the masking conditions in a state in which the masking conditions are no longer satisfied after masking has been performed.

According to an aspect of an embodiment, a surveillance method may include: generating an image by capturing a surveillance area; and performing masking on a target object included in the image based on masking conditions for the target object being satisfied, where the masking conditions are based on at least one of a distance between the target object and a reference object included in the image and an overlapping area between the target object and the reference object included in the image.

The performing masking on the target object may include masking an entirety or a predefined part of the target object.

The surveillance method may further include: maintaining masking on the target object in a state in which the masking conditions are no longer satisfied after masking has been performed.

The surveillance method may further include: performing on-site training of an object in the image using an artificial intelligence (AI) model based on a user input setting the object as the target object or the reference object.

The surveillance method may further include: detecting the target object and the reference object included in the image using the AI model.

The specific details of other embodiments are included in the detailed description and drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a surveillance system according to an embodiment;

FIG. 2 is a block diagram of a surveillance apparatus according to an embodiment;

FIG. 3 is a block diagram of an image processing module illustrated in FIG. 2 according to an embodiment;

FIG. 4 is a diagram illustrating an image containing an object according to an embodiment;

FIG. 5 is a diagram illustrating how the object is detected from the image according to an embodiment;

FIG. 6 is a diagram illustrating an image containing a target object and a reference object according to an embodiment;

FIG. 7 is a diagram illustrating a target object overlapping with a reference object according to an embodiment;

FIG. 8 is a diagram illustrating masking performed on a target object according to an embodiment;

FIG. 9 is a diagram illustrating the maintenance of masking for a target object according to an embodiment;

FIG. 10 is a diagram illustrating multiple target objects overlapping with a reference object according to an embodiment;

FIG. 11 is a diagram illustrating an image containing an unset object according to an embodiment;

FIG. 12 is a diagram illustrating a target object overlapping with a reference object as configured by a user according to an embodiment;

FIG. 13 is a diagram illustrating masking performed on a target object according to an embodiment; and

FIG. 14 is a flowchart illustrating a surveillance method according to an embodiment.

### DETAILED DESCRIPTION

Exemplary embodiments of the present disclosure will hereinafter be described in detail with reference to the accompanying drawings. The advantages and features of the present disclosure, as well as methods of achieving them, will become apparent by referring to the embodiments described below in detail in conjunction with the accompanying drawings. However, the present disclosure is not limited to the embodiments disclosed below but can be implemented in various forms. The embodiments are merely provided to ensure the completeness of the disclosure and to fully convey the scope to those skilled in the art to which the disclosure pertains. Throughout the specification, the same reference numerals refer to the same components.

Unless otherwise defined, all terms (including technical and scientific terms) used herein may have meanings commonly understood by those skilled in the art to which the present disclosure pertains. Moreover, terms generally defined in dictionaries are not to be interpreted in an idealized or excessively formal sense unless explicitly defined otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

It will be understood that the terms “includes,” “comprises,” “has,” “having,” “including,” “comprising,” and the like when used in this specification, specify the presence of stated features, figures, steps, operations, components, members, or combinations thereof, but do not preclude the presence or addition of one or more other features, figures, steps, operations, components, members, or combinations thereof.

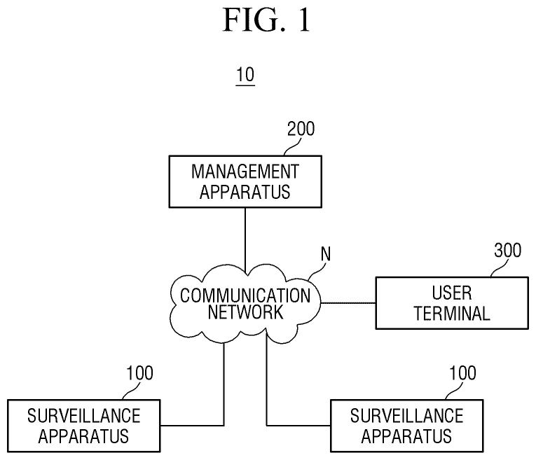

FIG. 1 is a diagram illustrating a surveillance system.

Referring to FIG. 1, a surveillance system 10 may include at least one surveillance apparatus 100, a management apparatus 200, a user terminal 300, and a communication network N.

The surveillance apparatus 100 may capture a surveillance area and may generate an image as a result of the capturing. The image generated by the surveillance apparatus 100 may include a still image or video.

The communication network N may provide a communication path between the surveillance apparatus 100 and the management apparatus 200. For example, the communication network N may include at least one of a wired network or a wireless network to enable communication between the surveillance apparatus 100 and the management apparatus 200. For example, the communication network N may include at least one of a wired network such as local area networks (LANs), wide area networks (WANs), metropolitan area networks (MANs), and integrated service digital networks (ISDNs), etc., a wireless network including wireless Internet such as 3G, 4G (LTE), 5G, Wi-Fi, Wireless Internet such as Wibro, Wimax, etc., a wireless network including short-distance communication and short distance networks, such as Bluetooth, radio frequency identification (RFID), Infrared Data Association (IrDA), Ultra Wideband (UWB), ZigBee, Near field communication (NFC), etc. The scope of the present disclosure is not limited thereto.

The image generated by the surveillance apparatus 100 may be transmitted to the management apparatus 200. The management apparatus 200 may store the image received from the surveillance apparatus 100 and transmit the stored image to the user. For example, the management apparatus 200 may be a video management system (VMS), a network video recorder (NVR), a digital video recorder (DVR), or a device including at least one of these.

The surveillance system 10 may include more than one surveillance apparatus 100. The management apparatus 200 may store images received from more than one surveillance apparatus 100 and provide the stored images to the user.

The image generated by the surveillance apparatus 100 may include an object that requires privacy protection. The surveillance apparatus 100 may be installed in a location with frequent human traffic, such as a hospital, hotel, or department store. However, if the surveillance apparatus 100 captures faces of individuals requiring privacy protection, privacy violations may occur.

To protect the privacy of an object, the surveillance apparatus 100 may perform masking on a certain object before transmitting an image to the management apparatus 200. For example, the surveillance apparatus 100 may analyze a captured image to detect an object requiring privacy protection, perform masking on the detected object, and then transmit the resulting image to the management apparatus 200. As a result, an image provided by the management apparatus 200 may include a masked object, ensuring the privacy of that object.

The management apparatus 200 may transmit information regarding the object requiring privacy protection to the surveillance apparatus 100. For example, if the surveillance system 10 is installed in a hospital, the management apparatus 200 may designate patients as objects requiring privacy protection and transmit this information to the surveillance apparatus 100. In this case, the surveillance apparatus 100 may perform masking on the patients and transmit the resulting masked image to the management apparatus 200. An object requiring privacy protection will hereinafter be referred to as a target object.

In an embodiment, to identify a target object in an image, the surveillance apparatus 100 may refer to spatial relationships with other objects. When a first object is close to or overlaps with a second object, the surveillance apparatus 100 may determine that the first object is a target object. The second object used for determining the target object is referred to as a reference object.

The surveillance apparatus 100 may use an artificial intelligence (AI) model installed in the surveillance apparatus 100 to detect and recognize a target object in a surveillance image. Additionally, the management apparatus 200 may transmit AI model data for a target object and a reference object to the surveillance apparatus 100. The surveillance apparatus 100 may detect the target object in the surveillance image by referencing the AI model installed thereon or the AI model data for the target object and the reference object received from the management apparatus 200, and transmit an image with the detected target object being masked. In other words, the surveillance apparatus 100 may detect only preset target and reference objects in an image and perform masking on the target object.

The user terminal 300 may access the management apparatus 200 and display an image captured by the surveillance apparatus 100. The user may use the image displayed on the user terminal 300 to review the monitoring results of the surveillance area. Additionally, the user terminal 300 may transmit control commands to the surveillance apparatus 100. The control commands may include commands for controlling the pan, tilt, or zoom of the surveillance apparatus 100 and commands for starting or stopping image capture.

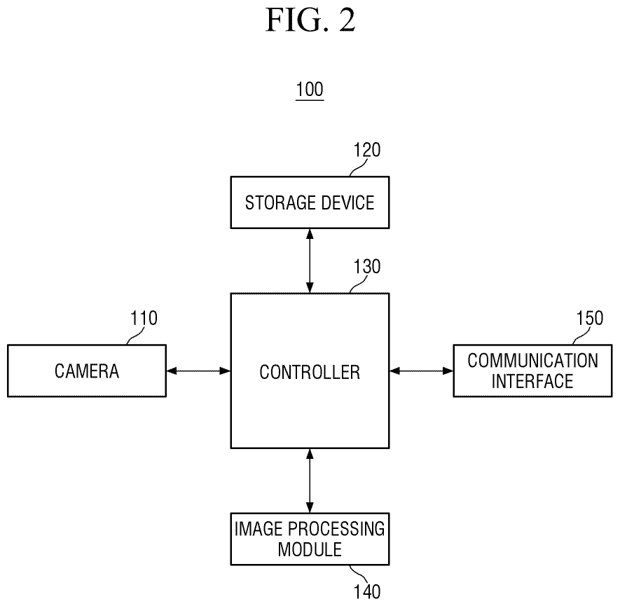

FIG. 2 is a block diagram of a surveillance apparatus according to an embodiment.

Referring to FIG. 2, the surveillance apparatus 100 may include a camera 110, a storage device 120, a controller 130, an image processing module 140, and a communication interface 150.

The camera 110 may capture a surveillance area, thereby generating an image. To generate an image, the camera 110 may include an image sensor such as a complementary metal-oxide-semiconductor (CMOS) device or a charge-coupled device (CCD). Additionally, the camera 110 may be equipped with pan-tilt equipment for changing the direction of capture and may also include a zoom lens for enlarging or reducing a subject.

The storage device 120 may temporarily or permanently store the image generated by the camera 110. Additionally, the storage device 120 may store the image processed by the image processing module 140. The storage device 120 may also store masking conditions that will be described later. The image processing module 140 may perform masking on an image according to the masking conditions. Furthermore, the storage device 120 may store AI model data used for detecting a target object and a reference object. The storage device 120 may include one or more memory modules. Alternatively or additionally, the storage device may be implemented as an external memory device, a hard disk, and/or an optical disk, a cloud storage, etc. However, the scope of the present disclosure is not limited thereto.

The image processing module 140 may perform masking on a target object included in an image when masking conditions for the target object are satisfied. The image processing module 140 may detect the target object in the image. The image processing module 140 may continuously check whether the masking conditions for the target object are satisfied. When the masking conditions for the target object are satisfied, the image processing module 140 may generate an image with the target object masked. Conversely, if the masking conditions for the target object are not satisfied, the image processing module 140 may maintain the unmasked image. The image with the target object masked will hereinafter be referred to as a masked image. The image processing module 140 may be included in the surveillance apparatus 100 or the management apparatus 200, and may be implemented as any combination of hardware and/or software. When the image processing module 140 is included in the management apparatus 200, the image processing module 140 may detect the target object in an image received from the surveillance apparatus 100 via the communication network N and perform masking on the target object if the masking conditions for the target object are satisfied.

In an embodiment, the masking conditions may include at least one of the distance and the overlapping area between the target object and the reference object included in an image. For example, if the distance between the target object and the reference object is less than a preset threshold distance, the masking conditions may be satisfied, and the image processing module 140 may generate a masked image. In an embodiment, if the overlapping area between the target object and the reference object exceeds a preset threshold area, the masking conditions may be satisfied, and the image processing module 140 may generate a masked image.

The communication interface 150 may transmit an image processed by the image processing module 140 to the management apparatus 200. The image processed by the image processing module 140 may be a masked or unmasked image. The communication interface 150 may include any one or any combination of a digital modem, a radio frequency (RF) modem, an antenna circuit, a WiFi chip, and related software and/or firmware.

The controller 130 may perform overall control of the camera 110, the storage device 120, the image processing module 140, and the communication interface 150. In one or more embodiments, the controller 130 may include one or more processors. The one or more processors may include one or more of a central processing unit (CPU), a many integrated core (MIC), a field-programmable gate array (FPGA), a digital signal processor (DSP), a hardware accelerator, or the like. The one or more processors are able to perform control of any one or any combination of the camera 110, the storage device 120, the image processing module 140, and the communication interface 150. The one or more processors execute one or more programs stored in a memory.

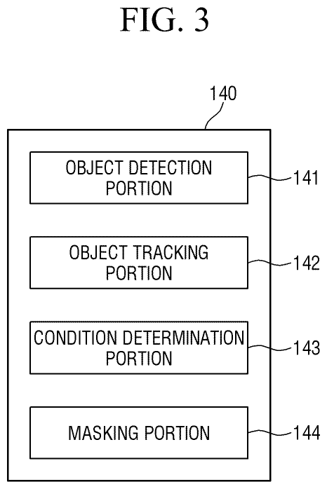

FIG. 3 is a block diagram of the image processing module 140 illustrated in FIG. 2.

Referring to FIG. 3, the image processing module 140 may include an object detection portion 141, an object tracking portion 142, a condition determination portion 143, and a masking portion 144.

The object detection portion 141 may perform the role of detecting objects in an image. To this end, the object detection portion 141 may utilize an object detection model. For example, the object detection portion 141 may detect objects in an image using an object detection model such as Region-based Convolutional Neural Network (R-CNN) or the You Only Look Once (YOLO) algorithm. The YOLO algorithm has a relatively fast detection speed for objects in an image and thus, in some examples, may be a suitable AI algorithm for surveillance cameras that process real-time videos. The YOLO algorithm operates differently from object detection algorithms such as faster R-CNN, Region-based Fully Convolutional Network (R-FCN), or Feature Pyramid Network based Faster R-CNN (FPN-FRCN). The YOLO algorithm may resize an input image and output results by passing it through a single neural network only once. The results output by the YOLO algorithm may include bounding boxes indicating the locations of objects and classification probabilities indicating what the objects are.

In an embodiment, the object detection portion 141 may detect target and reference objects in an image. AI model data for detecting target and reference objects may utilize data installed in the surveillance apparatus 100 or be received from the management apparatus 200. The object detection portion 141 may use an AI model to detect target and reference objects in an image. For example, the surveillance apparatus 100 may newly recognize objects in the field that cannot be recognized by existing surveillance apparatuses through user input from the management apparatus 200 or the user terminal 300. For example, the user may designate a bed as a newly recognized object in an image captured by the surveillance apparatus 100, and based on this user designation, the surveillance apparatus 100 may perform on-site learning using the installed AI model to enable recognition of a bed. The object detection portion 141 may detect a person in an image as a target object and newly recognize a bed in an image as a reference object.

The object tracking portion 142 may perform the role of tracking objects detected by the object detection portion 141. For example, the object tracking portion 142 may use the DeepSORT algorithm to track objects. If the object detection portion 141 detects a target object, the object tracking portion 142 may track that target object.

The YOLO algorithm used by the object detection portion 141 and the DeepSORT algorithm used by the object tracking portion 142 are lightweight AI algorithms, and can perform object detection and tracking on images with relatively low computational demand.

The condition determination portion 143 may determine whether masking conditions for a target object are satisfied. For example, if the masking conditions involve the distance between the target object and a reference object, the condition determination portion 143 may determine whether the distance between the target object and the reference object is less than a threshold distance. In an embodiment, if the masking conditions involve the overlapping area between the target object and the reference object, the condition determination portion 143 may determine whether the overlapping area exceeds a threshold area.

The condition determination portion 143 may continuously determine whether the masking conditions are satisfied for an image generated by the camera 110. The camera 110 may generate and transmit an image in real time, and the condition determination portion 143 may determine in real time whether the masking conditions are satisfied for the image generated in real time.

The masking portion 144 may perform masking on the target object for which the masking conditions are satisfied. According to the determination results from the condition determination portion 143, if the masking conditions for the target object are satisfied, the masking portion 144 may perform masking on that target object. Consequently, a privacy mask that conceals the target object may be added to the image, thereby generating a masked image.

The masking portion 144 may perform masking on the entirety or a predefined part of the target object. For example, if the target object is a person, the masking portion 144 may generate and add a privacy mask that conceals the entire body of the person or a privacy mask that conceals only the head to the image.

Even when the masking conditions for the target object are no longer satisfied after masking has been performed, the masking portion 144 may maintain the masking for that target object. For example, when the distance between the target object and the reference object is less than the threshold distance, the masking portion 144 may perform masking on the target object. Then, the distance may later be increased to exceed the threshold. In this case, the masking portion 144 may still maintain the masking for the target object. Similarly, the masking portion 144 may perform masking because the overlapping area between the target object and the reference object exceeds the threshold area, and later, the overlapping area may decrease to fall below the threshold. In this case, the masking portion 144 may also maintain the masking for the target object.

If a target object requiring privacy protection is detected, the masking portion 144 may continuously perform masking to ensure the privacy of the target object is protected.

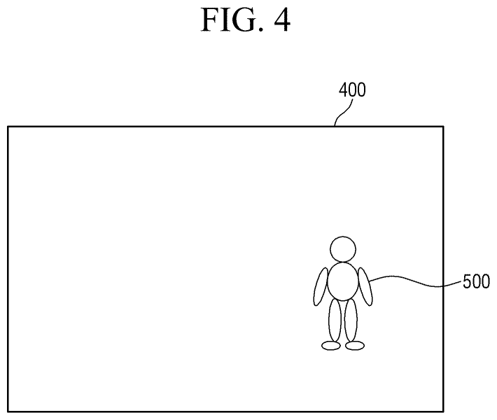

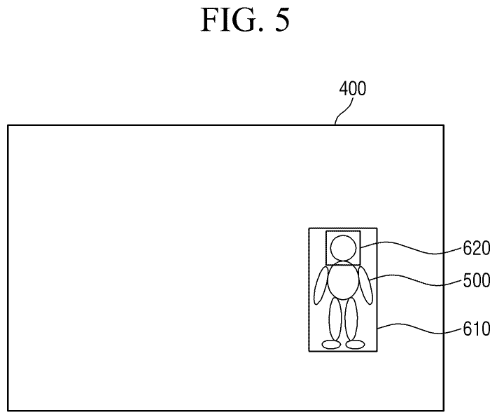

FIG. 4 is a diagram illustrating an image containing an object, and FIG. 5 is a diagram illustrating how the object is detected from the image.

Referring to FIGS. 4 and 5, an image 400 may include an object 500, and the object detection portion 141 may detect the object 500 included in the image 400.

The object detection portion 141, which detects the object 500 using the R-CNN or YOLO algorithm, may set a first region 610 and a second region 620 in the object 500. The entire body of the object 500 may be set as the first region 610, and a part of the body of the object 500 may be set as the second region 620.

The object 500 may include a person, and the part of the body of the object 500 may include the person's head. In this case, the object detection portion 141 may set the entire body of the person as the first region 610 and the person's head as the second region 620.

FIGS. 4 and 5 illustrate an image 400 containing a single object 500, but the image 400 may include multiple objects 500. In this case, the object detection portion 141 may simultaneously detect the multiple objects 500.

When the object 500 is detected by the object detection portion 141, the object tracking portion 142 may track the object 500 within the image 400.

As the object tracking portion 142 tracks the object 500, the first region 610 and the second region 620 defined by the object detection portion 141 may move within the image 400 along with the object 500.

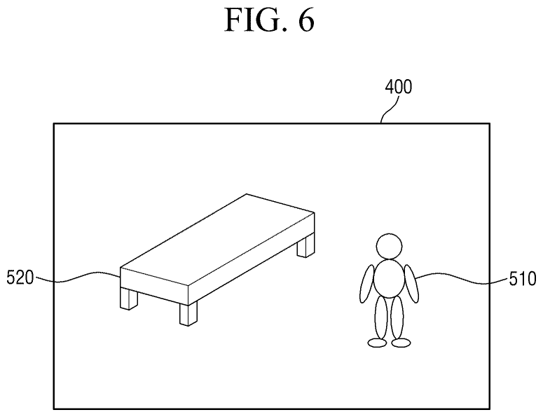

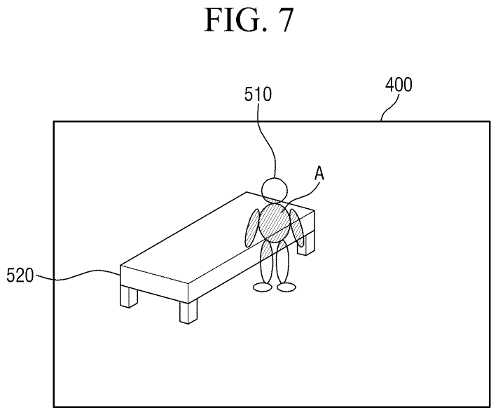

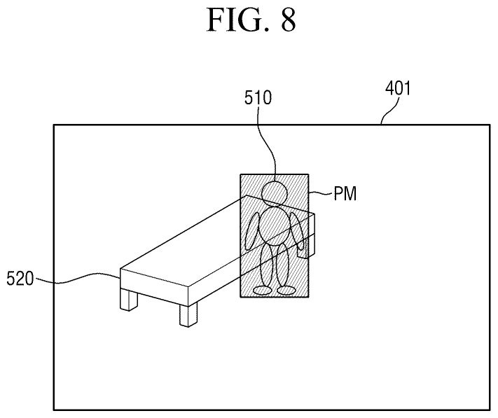

FIG. 6 is a diagram illustrating an image containing a target object and a reference object, FIG. 7 is a diagram illustrating the target object overlapping with the reference object, and FIG. 8 is a diagram illustrating masking performed on the target object.

Referring to FIG. 6, the image 400 may include a target object 510 and a reference object 520.

The object detection portion 141 may detect the objects in the image 400 using an AI algorithm. The objects detected by the object detection portion 141 may include the target object 510 and the reference object 520. If the image 400 contains the target object 510 and the reference object 520, the object detection portion 141 may detect both.

Referring to FIG. 7, the target object 510 may move and overlap with the reference object 520.

The condition determination portion 143 may continuously determine whether masking conditions for the target object 510 are satisfied. The masking conditions may include an overlapping area A between the target object 510 and the reference object 520.

If the overlapping area A between the target object 510 and the reference object 520 exceeds a threshold area, the condition determination portion 143 may notify the masking portion 144 that the target object 510 is a masking target.

Referring to FIG. 8, the masking portion 144 may perform masking on the target object 510, which may be a masking target.

As illustrated in FIG. 8, the masking portion 144 may mask the entirety of the target object 510, or may mask a part of the target object 510. The part of the target object 510 to be masked may be predefined. For example, if the target object 510 is a person, the head may be considered a part of the target object 510.

When masking is performed, a privacy mask PM that conceals the entire target object 510 or part of the target object 510 may be added to the image 400.

The image with the privacy mask PM added, i.e., a masked image 401, may be transmitted to the management apparatus 200 via the communication interface 150, and the management apparatus 200 may receive the masked image 401, from which information regarding the target object 510 has been removed. In an embodiment, the surveillance apparatus 100 may transmit the image containing the target object 510 and the reference object 520 without masking, along with attribute information of the objects included in the image, to the management apparatus 200. In this case, the management apparatus 200 may perform masking on the received image to generate the masked image 401.

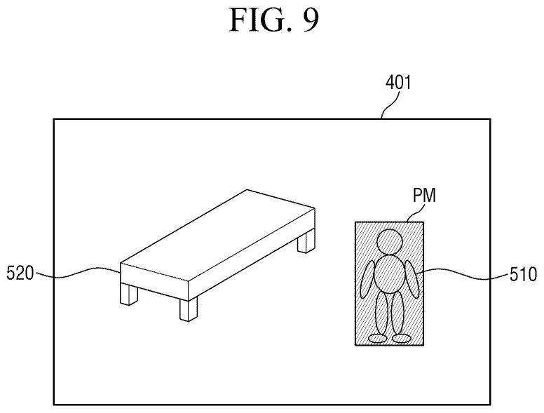

FIG. 9 is a diagram illustrating an example of maintaining the masking for a target object.

Referring to FIG. 9, once masking has been performed on the target object 510, the masking portion 144 may maintain the masking for the target object 510.

When masking is yet to be performed on the target object 510, it may have not yet been determined whether the target object 510 is a masking target. Accordingly, an unmasked image 400 containing the target object 510 may be transmitted to the management apparatus 200.

Once masking has been performed on the target object 510, it may have already been confirmed that the target object 510 is a masking target. Therefore, once masking has been performed on the target object 510, which is a masking target, the masking portion 144 may maintain the masking to protect the privacy of the target object 510.

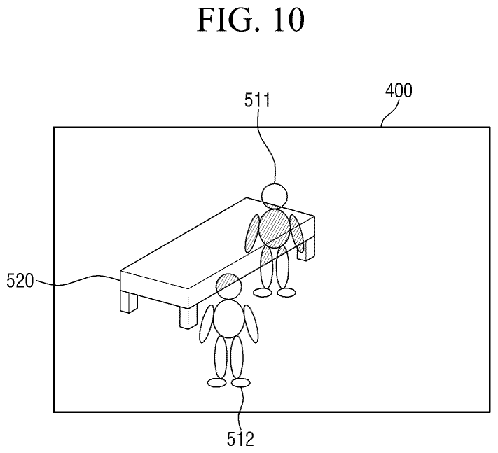

FIG. 10 is a diagram illustrating multiple target objects overlapping with a reference object.

Referring to FIG. 10, multiple target objects 511 and 512 may overlap with a reference object 520.

The condition determination portion 143 may determine whether masking conditions are satisfied for each of the target objects 511 and 512. The condition determination portion 143 may determine a target object that satisfies the masking conditions as being a masking target and notify the masking portion 144.

However, when the target objects 511 and 512 are both determined to be masking targets for a single reference object 520, information may be concealed unnecessarily. For example, the identity of patients may need to be protected, but the identity of doctors or nurses may not need to be concealed.

Accordingly, when multiple target objects satisfying the masking conditions are included in the image 400, the masking portion 144 may perform masking only on the target object that first satisfies the masking conditions. In some examples, target objects requiring privacy protection may be more likely to be closer to the reference object 520. Therefore, the masking portion 144 may perform masking only on the target object that first satisfies the masking conditions.

However, performing masking on only one of the target objects 511 and 512 is merely exemplary. According to some embodiments, the masking portion 144 may perform masking on all the target objects 511 and 512 that satisfy the masking conditions.

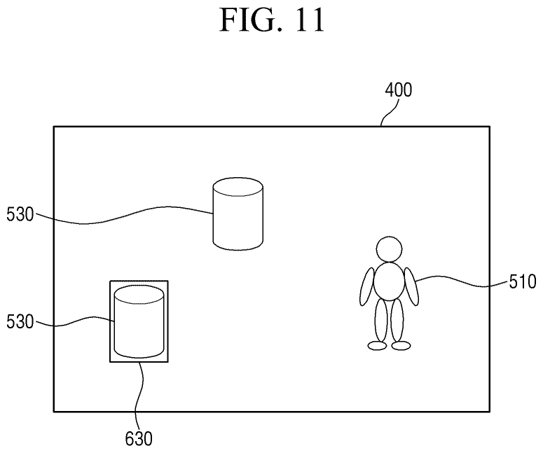

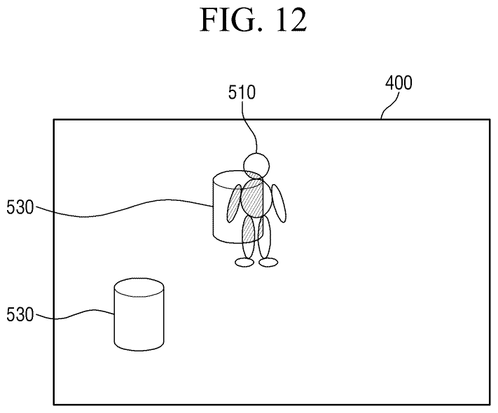

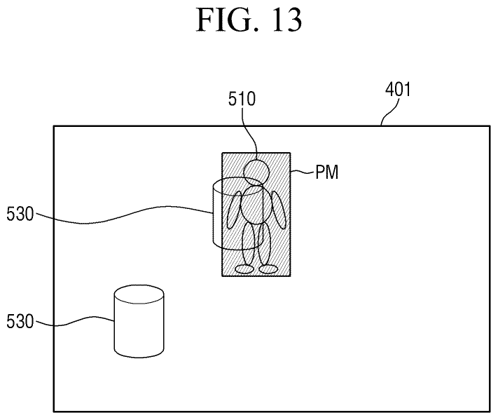

FIG. 11 is a diagram illustrating an image containing an unset object, FIG. 12 is a diagram illustrating a target object overlapping with a reference object as configured by a user, and FIG. 13 is a diagram illustrating masking performed on a target object.

Referring to FIG. 11, the image 400 may include an unset object 530.

The unset object 530 refers to an object that has not been set as either a target object or a reference object. In other words, the unset object 530 represents an object that cannot be recognized by the surveillance apparatus 100. For example, the unset object 530 may not be able to recognized by the surveillance apparatus 100 without additional setting by the user.

The user may set the unset object 530 included in the image 400 as a target object or a reference object by using a console connected to the user terminal 300 or the management apparatus 200. To this end, the user may select the unset object 530 included in the image 400. For example, the user may form a selection box 630 around at least a portion of the unset object 530 in the image 400. The unset object 530 included in the selection box 630 may be designated and learned as an object to be newly recognized, through the AI model installed in the surveillance apparatus 100. Once learning is completed, the unset object 530 may become newly recognizable in the image 400. Through this on-site learning process, the surveillance apparatus 100 can learn and recognize objects in the field that the user wishes to newly recognize in the image 400 and designate the newly recognized objects as target objects or reference objects.

FIG. 11 is a diagram illustrating an image 400 containing two unset objects 530 of the same type. When the unset objects 530 are newly learned and recognized in the field through user designation, the surveillance apparatus 100 may recognize both unset objects 530 as either target objects or reference objects. The description will hereinafter primarily focus on a case where the two unset objects 530 are set as reference objects.

As illustrated in FIGS. 12 and 13, when a target object 510 approaches or overlaps with a newly set reference object, the surveillance apparatus 100 may generate a masked image 401 by adding a privacy mask PM to the image 400 to conceal the target object 510.

In this manner, the user can easily set the unset objects 530 included in the image 400 as target objects or reference objects.

AI model data for the unset objects 530 has been described as being generated by the management apparatus 200, but in some embodiments, the AI model data for unset objects 530 may be generated by the surveillance apparatus 100 or the user terminal 300. For example, the controller 130 of the surveillance apparatus 100 may generate the AI model data for the unset objects 530. In this case, the surveillance apparatus 100 may use the generated AI model data or AI model data provided by the user terminal 300 to detect target objects or reference objects.

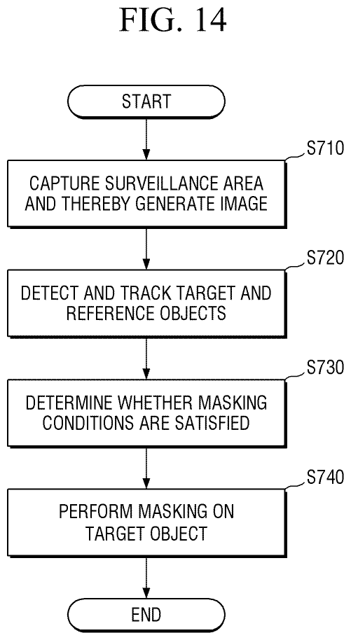

FIG. 14 is a flowchart illustrating a surveillance method according to an embodiment.

Referring to FIG. 14, to generate a masked image 401, the camera 110 of the surveillance apparatus 100 may first capture a surveillance area, thereby generating an image 400.

The image 400 generated by the camera 110 may include multiple objects. Among these multiple objects, a target object 510 and a reference object 520 may be included. The object detection portion 141 may detect the target object 510 and the reference object 520 included in the image 400, and the object tracking portion 142 may continuously track the target object 510 and reference object 520 detected by the object detection portion 141.

The condition determination portion 143 may determine whether masking conditions for the target object 510 are satisfied. The masking conditions may include at least one of the distance and the overlapping area between the target object 510 and the reference object 520.

When the masking conditions for the target object 510 included in the image 400 are satisfied, the masking portion 144 may perform masking on the target object 510. The target object 510 may be concealed by a privacy mask PM, and the masked image 401 may be transmitted to the management apparatus 200. Since the management apparatus 200 maintains only the masked image 401, from which image information of the target object 510 has been removed, the image information of the target object 510 is not exposed to users connected to the management apparatus 200. Furthermore, according to an embodiment, objects can be newly learned for recognition as needed in the field, enabling new forms of masking based on overlapping or distance relationships of newly recognized objects.

As is traditional in the field, embodiments illustrated in FIGS. 2 and 3 are described in terms of functional blocks, portions, units and/or modules. Those skilled in the art will appreciate that these blocks, portions, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, portions, units and/or modules being implemented by microprocessors or similar, they may be programmed using software (e.g., microcode) to perform various functions discussed herein and may optionally be driven by firmware and/or software. Alternatively, each block, portion, unit and/or module may be implemented by dedicated hardware, or as a combination of dedicated hardware to perform some functions and a processor (e.g., one or more programmed microprocessors and associated circuitry) to perform other functions. Also, each block, portion, unit and/or module of the embodiments may be physically separated into two or more interacting and discrete blocks, portions, units and/or modules without departing from the present scope. Further, the blocks, portions, units and/or modules of the embodiments may be physically combined into more complex blocks, portions, units and/or modules without departing from the present scope.

According to the surveillance apparatus and method described above, a privacy mask may be applied to objects within a surveillance area that require privacy protection, thereby providing the advantage of preventing the identity of the selected objects from being exposed.

The effects of the present disclosure are not limited to the advantages mentioned above, and other effects not explicitly stated may be understood by those skilled in the art from the descriptions in the claims.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A surveillance apparatus comprising:
a memory storing instructions; and
one or more processors configured to execute the instructions,
wherein, by executing the instructions, the one or more processors are configured to control:
a camera to generate an image by capturing a surveillance area, and
an image processing module to perform masking on a target object included in the image based on masking conditions for the target object being satisfied, and
wherein the masking conditions are based on at least one of a distance between the target object and a reference object included in the image, and an overlapping area between the target object and the reference object included in the image.

2. The surveillance apparatus of claim 1, wherein the one or more processors are further configured to control the image processing module to:
detect the target object and the reference object included in the image; and
track the detected target object.

3. The surveillance apparatus of claim 1, wherein the one or more processors are further configured to control the image processing module to perform masking on an entirety of the target object or a predefined part of the target object.

4. The surveillance apparatus of claim 3, wherein the one or more processors are further configured to control the image processing module to maintain masking on the target object in a state in which the masking conditions are no longer satisfied after masking has been performed.

5. The surveillance apparatus of claim 3, wherein the one or more processors are further configured to control the image processing module to, based on multiple target objects in the image satisfying the masking conditions, perform masking only on a target object that first satisfies the masking conditions.

6. The surveillance apparatus of claim 3, wherein based on the target object being a person, the predefined part comprises a head of the person.

7. The surveillance apparatus of claim 1, wherein the one or more processors are further configured to perform on-site training of an object in the image using an artificial intelligence (AI) model based on a user input setting the object as the target object or the reference object.

8. A surveillance system comprising:
a surveillance apparatus configured to generate an image by capturing a surveillance area;
a management apparatus configured to store the image; and
a user terminal connected to the management apparatus and configured to output the image,
wherein the surveillance apparatus comprises one or more processors configured to control an image processing module to perform masking on a target object included in the image based on masking conditions for the target object being satisfied, and
wherein the masking conditions are based on spatial relationships between the target object and a reference object included in the image.

9. The surveillance system of claim 8, wherein the spatial relationships are based on at least one of a distance between the target object and the reference object and an overlapping area between the target object and the reference object.

10. The surveillance system of claim 8, wherein the one or more processors of the surveillance apparatus are further configured to perform on-site training of an object in the image using an artificial intelligence (AI) model based on a user input setting the object as the target object or the reference object.

11. A surveillance method comprising:
generating an image by capturing a surveillance area; and
performing masking on a target object included in the image based on masking conditions for the target object being satisfied,
wherein the masking conditions are based on at least one of a distance between the target object and a reference object included in the image and an overlapping area between the target object and the reference object included in the image.

12. The surveillance method of claim 11, wherein the performing masking on the target object comprises masking an entirety or a predefined part of the target object.

13. The surveillance method of claim 11, further comprising:
maintaining masking on the target object in a state in which the masking conditions are no longer satisfied after masking has been performed.

14. The surveillance method of claim 11, further comprising:
performing on-site training of an object in the image using an artificial intelligence (AI) model based on a user input setting the object as the target object or the reference object.

15. The surveillance method of claim 14, further comprising:
detecting the target object and the reference object included in the image using the AI model.

16. The surveillance apparatus of claim 1, wherein the masking conditions are satisfied based on at least one of:
the distance between the target object and the reference object being less than a predetermined threshold, and
the overlapping area between the target object and the reference object exceeding a preset threshold area.

17. The surveillance apparatus of claim 7, wherein the one or more processors are further configured to control the image processing module to:
detect the target object and the reference object included in the image using the AI model,
track the reference object and the target object included in the image, and
determine that the masking conditions are satisfied based on at least one of:
the distance between the target object and the reference object being less than a predetermined threshold, and
the overlapping area between the target object and the reference object exceeding a preset threshold area.

18. The surveillance system of claim 10, wherein the one or more processors of the surveillance apparatus are further configured to control the image processing module to:
detect the target object and the reference object included in the image using the AI model,
track the target object and the reference object included in the image, and
determine that the masking conditions are satisfied based on at least one of:
a distance between the target object and the reference object being less than a predetermined threshold, and
an overlapping area between the target object and the reference object exceeding a preset threshold area.

19. The surveillance system of claim 18, wherein the one or more processors of the surveillance apparatus are further configured to control the image processing module to, based on multiple target objects in the image satisfying the masking conditions, perform masking only on a target object that first satisfies the masking conditions.

20. The surveillance system of claim 19, wherein the one or more processors of the surveillance apparatus are further configured to control the image processing module to maintain masking on the target object that first satisfies the masking conditions in a state in which the masking conditions are no longer satisfied after masking has been performed.
